(19) United States
(12) Patent Application Publication
(10) Pub. No.: US 2024/0330371 A1
(43) Pub. Date: Oct. 3, 2024

(54) NEURAL NETWORK STRUCTURE SEARCH DEVICE AND NEURAL NETWORK STRUCTURE SEARCH METHOD

(71) Applicant: NEC Corporation, Tokyo (JP)

(72) Inventor: Kazutoshi HIROSE, Tokyo (JP)

(73) Assignee: NEC Corporation, Tokyo (JP)

(21) Appl. No.: 18/616,323

(22) Filed: Mar. 26, 2024

(30) Foreign Application Priority Data
Mar. 29, 2023 (JP) 2023-052559

(51) Int. Cl. G06F 16/903

(52) U.S. Cl. CPC G06F 16/90335

(57) ABSTRACT

The neural network structure search device that searches for a neural network architectures includes a calculation compression unit that compiles multiple operations as candidates for search included in an operation space into a single operation, and the architecture determination unit that determines the architecture with high performance from the candidate architectures that include the compiled operations.

### CROSS-REFERENCE TO RELATED APPLICATION

This application is based upon and claims the benefit of priority from the prior Japanese Patent Application No. 2023-052559, filed Mar. 29, 2023, the entire contents of which are incorporated herein by reference.

### BACKGROUND OF THE INVENTION

### Field of the Invention

This invention relates to a neural network structure search device and a neural network structure search method that searches for a neural network architecture.

### Description of the Related Art

A neural network is a model of machine learning with multiple layers of nonlinear processing to infer an output for a given input. A technology for deriving an optimal architecture of a neural network (optimal structure of a neural network) is the Network Architecture Search (NAS). The NAS searches, for example, a type of nonlinear processing of a neural network and connection points of layers.

An example of the NAS is described in Patent Literature 1 and Non-Patent Literature 1. The architecture search system described in Patent Literature 1 includes a calculation cell generator that defines calculation cell, a calculation cell parameter adjustment engine, and an architecture generator. The calculation cell includes a directed graph representing nodes and edges. Each node represents a neural network latent representation. Each edge represents an operation that transforms the neural network latent representation.

The calculation cell parameter adjustment engine replaces the operation of transforming the latent representation with the operation of linear combination of candidate operation with weight. The calculation cell parameter adjustment engine adjusts a calculation cell hyperparameter and weight. The architecture generator generates a neural network using the adjusted calculation cell hyperparameter and weight.

Non-patent literature 1 also describes a NAS using a calculation cell. The system described in Non-Patent Literature 1 includes architecture sampling means, architecture evaluation means, architecture performance prediction means, an architecture storage device, and parameter search means.

The system described in Non-Patent Literature 1 randomly samples an architecture from search space and uses the samples to train a decision forest (random forest). The system searches new region while keeping track of the distribution of good architectures. After the entire search space has been sufficiently searched by the random forest, the system selects the architecture with the largest probability from the distribution as the optimal solution.
[Patent Literature 1] Japanese Patent Application Publication (Translation of PCT Application) No. 2022-545038
[Non-Patent Literature 1] Xiawu Zheng, “Neural Architecture Search with Representation Mutual Information,” 2022 IEEE/CVF Conference on Computer Vision and Pattern Recognition (CVPR), Sep. 27, 2022.

### SUMMARY OF THE INVENTION

In the system described in Non-Patent Literature 1, increasing the sample size makes it more difficult to search for an architecture. The reason is that the system converts the input to the random forest into a one-hot vector before inputting it to the random forest, which increases the search space exponentially and makes it difficult to train the performance predictor. In addition, as the training data required to train the random forest increases, the number of times it must be sampled also increases. This also makes training more time consuming.

In the system described in Patent Literature 1, when a calculation cell contains many candidate operations, the amount of memory required in the search for a calculation cell is large, and the space of architecture that can be searched is constrained by the performance of the computer. The reason is that in this system, candidate operations are weighted by calculation cell hyperparameters, a calculation cell is constructed by linearly combining them, and it is necessary to calculate the calculation cell hyperparameters by the gradient method.

The purpose of the present invention is to provide a neural network structure search device and a neural network structure search method that can reduce the amount of calculation and memory when searching for neural network structure.

A preferred aspect of the neural network structure search device is a neural network structure search device that searches for a neural network architecture includes a memory storing software instructions, and one or more processors configured to execute the software instructions to compile multiple operations as candidates for search included in an operation space into a single operation, and determine a high performance architecture from candidate architectures that include the compiled operation.

A preferred aspect of a neural network structure search method includes compiling multiple operations as candidates for search included in an operation space into a single operation by a computer, and determining a high performance architecture from candidate architectures that include the compiled operation by the computer.

A preferred aspect of a neural network structure search program causes a computer to execute a process of compiling multiple operations as candidates for search included in an operation space into a single operation, and a process of determining a high performance architecture from candidate architectures that include the compiled operation.

According to the present invention, reduces the amount of calculation and memory when searching for neural network structure.

### BRIEF DESCRIPTION OF THE DRAWINGS

FIG. 1 It depicts an explanatory diagram showing an example of a calculation cell used in the first example embodiment.

FIG. 2 It depicts an explanatory diagram showing a specific example of search space compression.

FIG. 3 It depicts a block diagram showing a configuration example of the neural network structure search device of the first example embodiment.

FIG. 4 It depicts an explanatory diagram showing a specific example of inputs to and outputs from the search space dimensionality compression means.

FIG. 5A It depicts an explanatory diagram showing a specific example of a candidate architecture.

FIG. 5B It depicts an explanatory diagram showing a specific example of a vector representation of a candidate architecture.

FIG. 6 It depicts a flowchart showing an operation of the neural network structure search device of the first example embodiment.

FIG. 7 It depicts a flowchart showing an operation of the neural network structure search device of the first example embodiment.

FIG. 8 It depicts an explanatory diagram showing an example of a calculation cell used in the second example embodiment.

FIG. 9 It depicts a block diagram showing a configuration example of the neural network structure search device of the second example embodiment.

FIG. 10 It depicts an explanatory diagram showing an example of inputs to and outputs from the parameter search means.

FIG. 11 It depicts a flowchart showing an operation of the neural network structure search device of the second example embodiment.

FIG. 12 It depicts a flowchart showing an operation of the neural network structure search device of the second example embodiment.

FIG. 13 It depicts a block diagram showing an example of a computer having a CPU.

FIG. 14 It depicts a block diagram showing the main part of the neural network structure search device.

### DESCRIPTION OF THE PREFERRED EMBODIMENTS

In the following example embodiments, the NAS that uses the concept of a calculation cell for architecture searching will be used as an example. A calculation cell contains a directed graph representing nodes and edges. In the following example embodiments, the amount of calculation required to search for neural network structures is reduced by compiling the operations represented by the edges of the calculation cell.

### Exemplary Embodiment 1

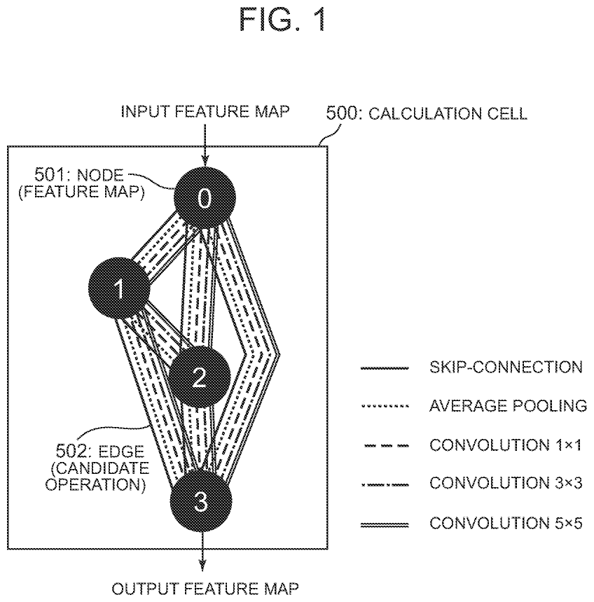

FIG. 1 is an explanatory diagram showing an example of a calculation cell used in the first example embodiment. As shown in FIG. 1, a calculation cell 500 is represented by a directed graph consisting of a node 501 representing a feature map of a neural network and an edge 502 representing one or more candidate operations between nodes. In this example embodiment, the calculation cell 500 is optimized. Optimization of the calculation cell 500 is to bring the calculation cell into a state where only one edge is selected that increases performance such as inference accuracy, model size, and execution speed of the network architecture.

The neural network structure search device of this example embodiment reduces the number of dimensions of the search space by treating operations of the same type or having the same role, or operations of the same type and having the same role, contained in the operation space as a single compressed operation representing. In other words, the neural network structure search device compiles multiple operations into a single operation to reduce the number of dimensions of the search space.

The same type of operation is two or more operations with different parameters, for example, a convolutional layer operation with a stride number of 1 and a convolutional layer operation with a stride number of 2. In that example, the parameter is the number of strides. Other examples of the same type of operation are an average pooling layer operation with a kernel size of 2×2 and an average pooling layer operation with a kernel size of 3×3. In that example, the parameter is the kernel size.

Another example of a role is the role of reducing the size of the feature map. In this case, an example of operations that have the same role is the operation of the convolutional layer with a stride number of 2 and the operation of the average pooling layer with a stride number of 2. Another example of a role is the role of performing a nonparametric operation on the feature map and outputting it to the next layer. In this case, an example of operations that have the same role is the operation of the average pooling layer with a stride number of 1 and the operation of the max pooling layer with a stride number of 1. Also, the number of repetitions of operations when multiple operations are included in one edge may also be positioned as a role.

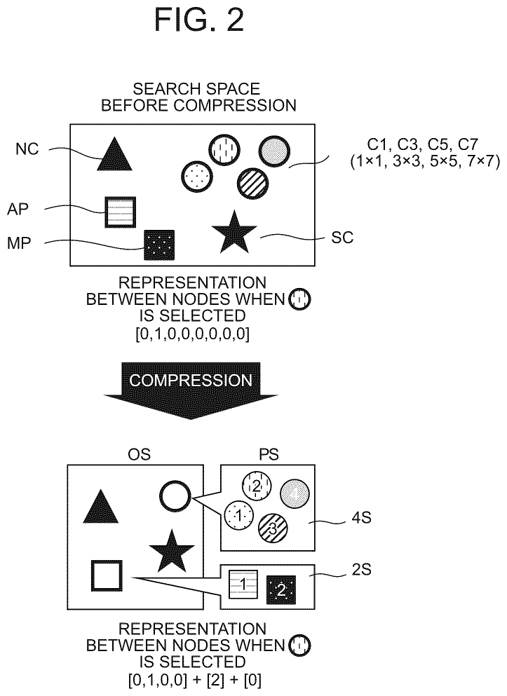

FIG. 2 is an explanatory diagram showing a specific example of search space compression. With reference to FIG. 2, changes in the search space due to compression will be explained. Suppose the search space before compression is an eight-dimensional space consisting of convolutional layer with 1×1 kernel, convolutional layer with 3×3 kernel, convolutional layer with 5×5 kernel, convolutional layer with 7×7 kernel, average pooling layer, max pooling layer, skip-connection, non-connection.

After compressing the same type of operation or operations with the same role into one operation, the operation space becomes a four-dimensional space consisting of a convolutional layer, a pooling layer, skip-connection, and non-connection. A parameter space becomes a two-dimensional space consisting of parameters related to the convolutional layer and parameters related to the pooling layer. In this example, the parameters related to the convolutional layer include four types: 1×1, 3×3, 5×5, and 7×7.

The operation space can be represented by a one-hot signal. The parameter space can be represented by a single value for the operation. In this example, the search space before compression is an eight-dimensional space, but after compression, the operation space is a four-dimensional space and the parameter space is a two-dimensional space. Therefore, the number of dimensions to represent candidate operations is reduced.

Hereinafter, example embodiments of the present invention will be explained with reference to the drawings.

In the first example embodiment, the neural network structure search device treats operations of the same type or having the same role contained within the operation space of candidates for search in a calculation cell as a single operation and defines a new post-compressed operation space. The neural network structure search device compresses the number of dimensions of the input features of the performance predictor by expressing the search space of the operations in the calculation cell in a vector form that combines the post-compressed operation space and the parameter space of the compressed operations.

Performance predictor are machine learning models such as random forests and neural networks. It trains the relationship between a calculation cell containing multiple operations and the performance of a network architecture using the calculation cell. Training makes it possible to predict and search performance for unknown architectures.

### [Description of Configuration]

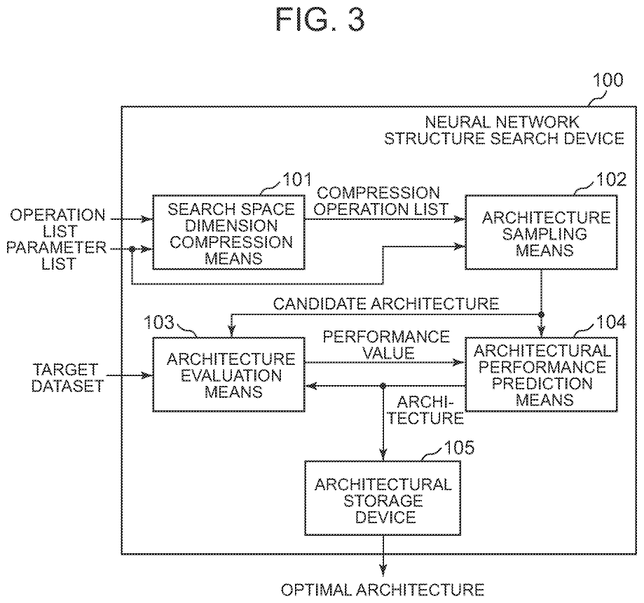

FIG. 3 is a block diagram showing a configuration example of the neural network structure search device 100 of the first example embodiment. The neural network structure search device 100 shown in FIG. 3 has search space dimensionality compression means 101, architecture sampling means 102, architecture evaluation means 103, architecture performance prediction means 104, and an architecture storage device 105. The arrows in FIG. 3 simply indicate the direction of signal (data) flow, but do not preclude bidirectionality. This is also true for the other block diagrams.

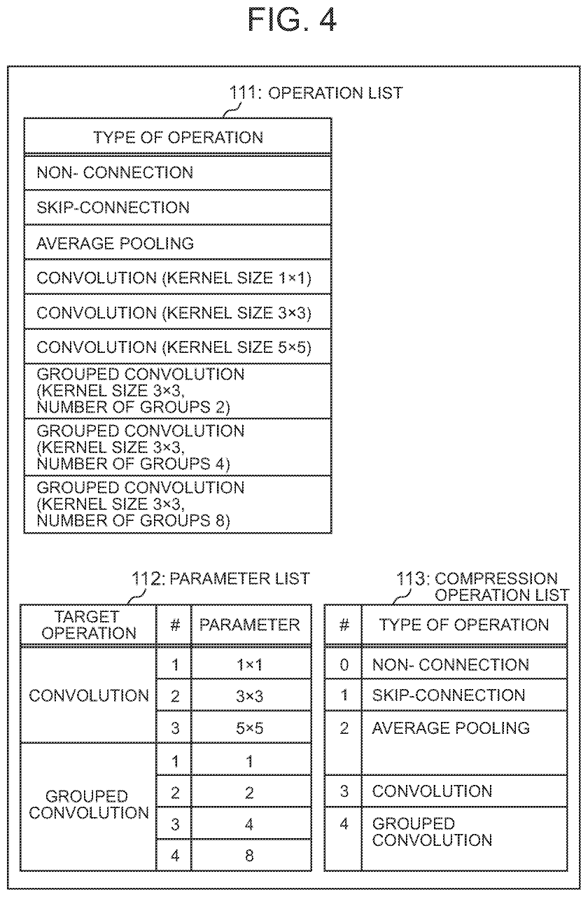

FIG. 4 is an explanatory diagram showing a specific example of inputs to and outputs from the search space dimensionality compression means 101. In the example shown in FIG. 4, the search space dimensionality compression means 101 inputs an operation list 111 and a parameter list 112 to be compressed. The search space dimensionality compression means 101 outputs a compression operation list 113.

The operation list 111 corresponds to the operation space to be searched. The operation list 111 contains all candidate operations (specifically, data indicating operations) in the calculation cell. The operations correspond to operations for constructing neural networks, such as convolutional layer operations (convolutional operations), all join operations, skip-connection, average pooling layer operations (average pooling operations), max pooling operations, and non-connection. Convolutional layer operations with different parameters such as kernel size and stride are treated as separate operations. For example, a convolutional layer operation with a 3×3 kernel is treated as a different operation from a convolutional layer operation with a 1×1 kernel.

For pooling operations, etc., operations with different parameters are treated as separate operations.

The parameter list 112 is a dictionary-type list from which different parameters within operations of the same type or having the same role in the operation list 111 are extracted. The parameter list 112 corresponds to the parameter space to be searched. The compression operation list 113 contains the types of operations compressed by the search space dimensionality compression means 101.

The architecture sampling means 102 inputs the compression operation list 113 and the parameter list 112 and outputs candidate architectures to be searched. The architecture sampling means 102 samples one or more architectures from among all architectures that can be configured using the input with an arbitrary probability distribution and outputs them as candidate architectures.

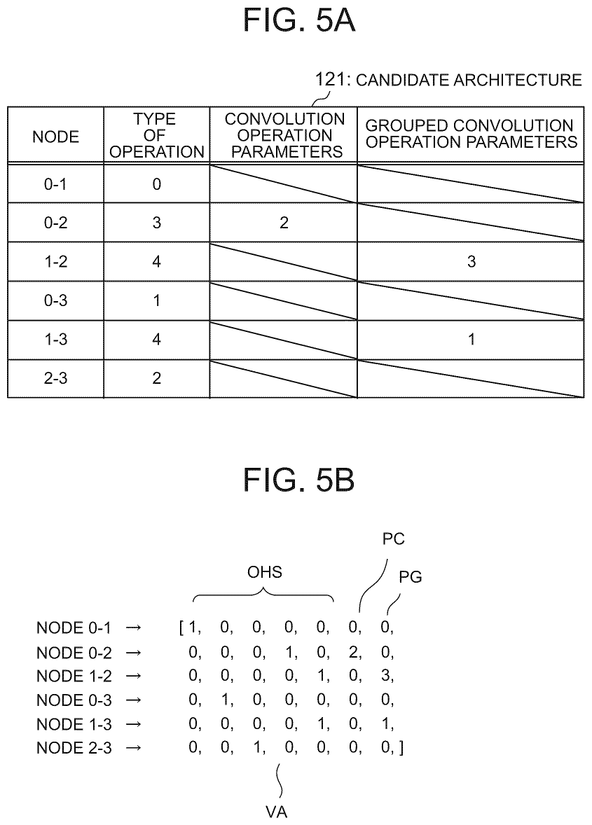

FIG. 5A is an explanatory diagram showing a specific example of a candidate architecture 121 output from the architecture sampling means 102. In FIG. 5A, node m-n (m, n: an integer greater than or equal to 0) indicates between nodes. That is, node m-n indicates an edge between node m and node n. In the example shown in FIG. 5A, the candidate architecture 121 is composed of types of operations and parameters for each of node m-n. FIG. 5B is an explanatory diagram showing a specific example of a vector representation of candidate architecture 121. In this example embodiment, as shown in FIG. 5B, the candidate architecture 121 is represented in a one-dimensional vector format for each operation between nodes in a calculation cell. The vector format is represented by combining the one-hot signalized values of the compression operation list 113 and the values of the parameter list 112 on a per-node basis when the candidate architecture 121 is created.

The architecture evaluation means 103 trains the weights of the network architecture for the target data set 114. The architecture evaluation means 103 outputs a single numerical value that represents the performance of the candidate architecture 121 using an arbitrary evaluation function. The target data set 114 is a data set of tasks targeted by the network architecture. The evaluation function is expressed in terms of values of an inference error, representation capability, computational complexity, a model size, etc., of the architecture or a weighted sum of these values.

The architecture performance prediction means 104 includes a machine learning model, such as a random forest, as the performance predictor described above. The architecture performance prediction means 104 performs the process of training a given input-output pair and inferring an output for an unknown input. The input value is the candidate architecture 121. The output value is the quantified performance of the architecture. The quantified performance of the architecture is the performance value.

The architecture storage device 105 stores multiple pairs of architectures, parameters, and the performance of the architecture. The architecture storage device 105 also outputs the best architecture (the architecture with the highest performance) among the stored architectures. Architectures are candidates in the compression operation list. Parameters are candidates in the parameter list.

### [Description of Operation]

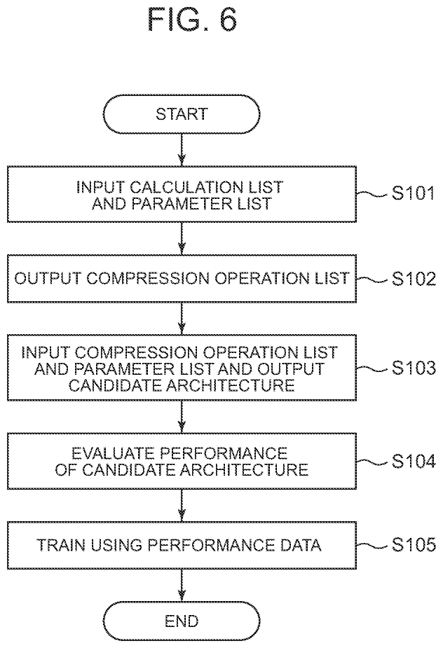

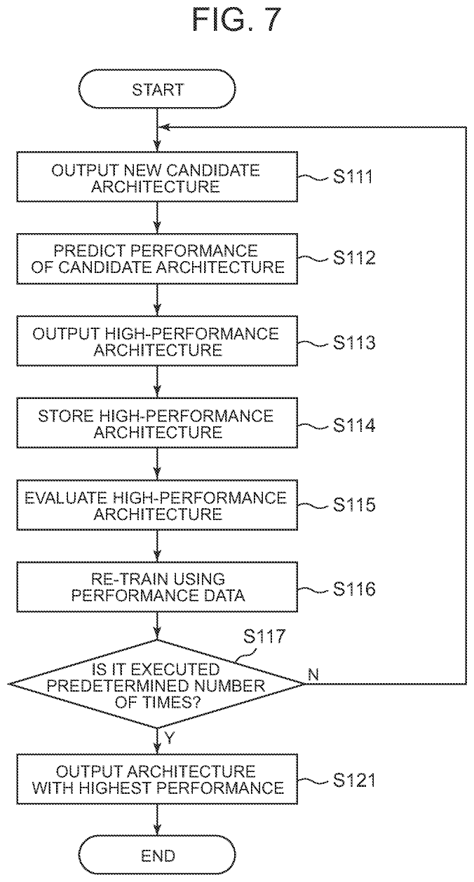

Next, the operation of the neural network structure search device 100 is described with reference to the flowcharts in FIG. 6 and FIG. 7. FIG. 6 shows the processing of the training phase of the performance predictor. FIG. 7 shows the processing of the reinforcement phase of the performance predictor and the architecture selection phase.

In the training phase of the performance predictor, the search space dimensionality compression means 101 receives as input a predefined calculation cell operation list 111 and a parameter list 112 to be compressed (step S101). Then, the search space dimensionality compression means 101 creates the compression operation list 113 based on the operation list 111 and the parameter list 112, and outputs the compression operation list 113 to the architecture sampling means 102 (step S102).

In step S102, the search space dimensionality compression means 101 compresses two or more operations in the operation list 111 that are subject to compression into a single compressed operation. The search space dimensionality compression means 101 describes the compressed operation (specifically, the data indicating the operation) in the compression operation list. The compression of operations means that operations of the same type or having the same role in the operation space are compiled into a single operation. In this example embodiment, the search space dimensionality compression means 101 compresses the same type of operation and the operation with the same role, but it may compress only one of the same type of operation and the operation with the same role.

The architecture sampling means 102 outputs the candidate architecture 121 in one-dimensional vector format (step S103). The vector can be expressed in the form of a vector of the compression operation list 113 combined with the values of the parameter list 112. In the compression operation list 113, the parameters are represented by the values themselves, or by index corresponding to the values, etc. The architecture evaluation means 103 receives the candidate architecture 121. The architecture evaluation means 103 evaluates the performance of the candidate architecture 121 using an evaluation function (step S104). In step S104, the architecture evaluation means 103 calculates, for example, criteria representing the performance. The architecture evaluation means 103 can also calculate criteria representing the performance of the candidate architecture using the input target data set 114.

The architecture performance prediction means 104 performs training using a machine learning model (step S105). In other words, the architecture performance prediction means 104 uses the candidate architecture 121 as input and the teacher data as performance to train the performance predictor.

Next, the reinforcement phase of the performance predictor is performed. In the reinforcement phase, as in the training phase, the architecture sampling means 102 outputs one or more new candidate architectures 121 to the architecture performance prediction means 104 (step S111). The architecture performance prediction means 104 predicts the performance of the candidate architectures 121 using the performance predictors trained in the training phase (step S112). The architecture performance prediction means 104 gives one or more of the architectures predicted to perform well among the multiple candidate architectures predicted, along with accompanying parameters, to the architecture storage device 105 and the architecture evaluation means 103 (step S113). The architecture storage device 105 stores the architecture predicted to have high performance (step S114).

The architecture evaluation means 103 evaluates the performance of the architecture using the evaluation function used in the training phase (step S115). The architecture evaluation means 103 outputs the performance values of the architecture to the architecture performance prediction means 104. The architecture performance prediction means 104 trains the performance predictor as in the training phase (step S116). As the performance predictor is re-trained, the prediction performance of the performance predictor is enhanced. Steps S111-S117 are repeated a predetermined number of times. By repeating steps S111-S117 a predetermined number of times, a certain number of architectures with high performance are stored in the architecture storage device 105. The predetermined number of repetitions is set to the number of times that a certain number of architectures with high performance are expected to be stored in the architecture storage device 105. The criteria (threshold) for determining whether or not the performance is high may be predetermined.

In the architecture selection phase, the architecture storage device 105 selects one of the stored architectures with the highest performance and outputs it (step S121). In this way, the architecture with the high performance is finally obtained.

### [Description of Effect]

In this example embodiment, the search space dimensionality compression means 101 generates a compression operation list 113 based on the search target operation list 111 and the corresponding parameter list 112. The search space dimensionality compression means 101 compresses the number of elements required to represent the candidate architecture. The candidate architecture is set up in the compression operation list 113 as a combination of data denoted by one-hot signals and a single value in the parameter list 112 expressed as an index or the like. Thus, the architecture can be represented with a small number of elements. As a result, the input dimension of the performance predictor can be reduced. Thus, the case of training and inference of the performance predictor is achieved.

In the prior art, similar operations with different parameters are represented as separate elements. Therefore, it is necessary for the performance predictor to train their relationship. In this example embodiment, however, the relationship is already expressed in terms of numerical values by indexes or other means. As a result, the complexity of training is reduced.

Although, in this example embodiment, the search for calculation cells in a CNN (Convolutional Neural Network: Convolutional Neural Network) was exemplified, the idea in this example embodiment can be applied to structural search for other neural networks, such as RNN (Recurrent Neural Network: Recurrent Neural Network) and Transformers.

### Exemplary Embodiment 2

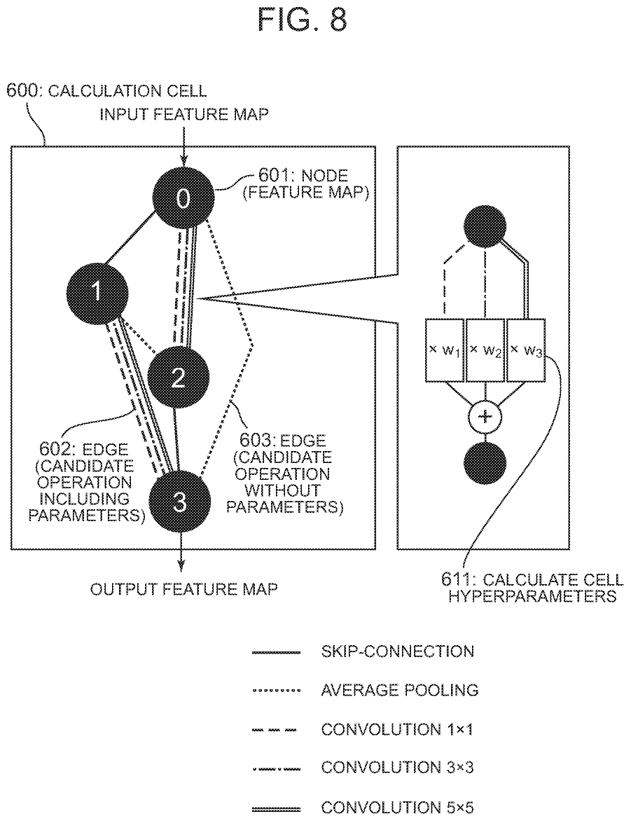

FIG. 8 is an explanatory diagram showing an example of a calculation cell used in the second example embodiment. As shown in FIG. 8, a calculation cell 600 is represented by a directed graph consisting of a node 601 representing a feature map of the neural network and edges 602 and 603 representing one or more candidate operations between nodes. In this example embodiment, the edge 602 corresponds to a candidate operation that contains a parameter. The edge 603 corresponds to a candidate operation that does not contain a parameter.

Candidate operations involving parameters corresponding to edge 602 are replaced by a parameterized weighted linear combination by the calculation cell hyperparameter 611.

In the second example embodiment, the neural network structure search device also treats operations of the same type or having the same role contained in the operation space that is a candidate for search in the calculation cell 600 as one operation, and defines a new post-compressed operation space. The neural network structure search device then searches the post-compressed operation space using the performance predictor and also searches the parameter space of the compressed operation.

In the second example embodiment, the neural network structure search device furthermore has a performance predictor that trains pairs of operations whose parameters in the calculation cells 600 are undetermined and their performance. The performance for architectures with unknown parameters is predicted by such a performance predictor. The parameters are then determined. As a method for determining the parameters, for example, the method described in Patent Literature 1.

### [Description of Configuration]

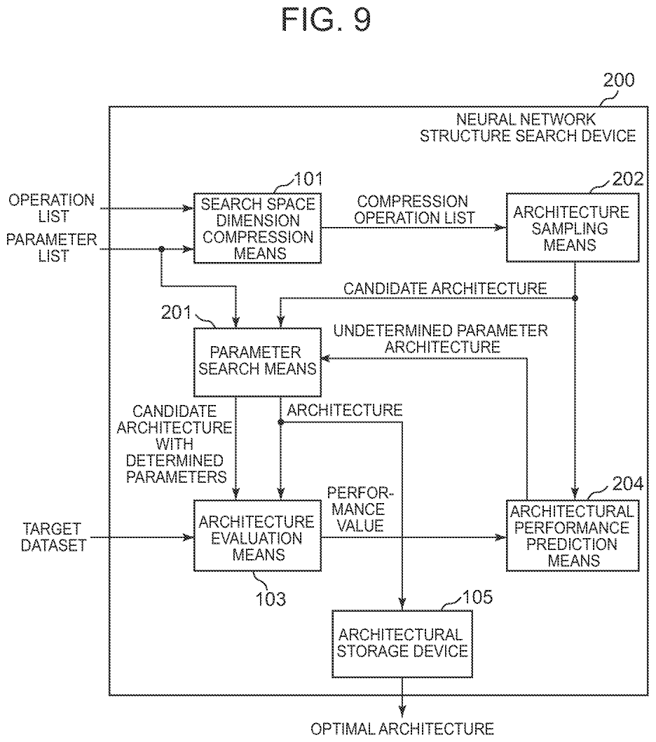

FIG. 9 is a block diagram showing a configuration example of the neural network structure search device 200 of the second example embodiment. The neural network structure search device 200 shown in FIG. 9 is equipped with search space dimensionality compression means 101, architecture sampling means 202, parameter search means 201, architecture evaluation means 103, architecture performance prediction means 204, and an architecture storage device 105.

The search space dimensionality compression means 101 is configured in the same way as the search space dimensionality compression means 101 shown in FIG. 3.

The architecture sampling means 202 inputs the compression operation list 113 (refer to FIG. 4) and outputs the candidate architectures 221 to be searched. The architecture sampling means 202 samples one or more architectures from among all architectures that can be configured using the input with an arbitrary probability distribution and outputs them as candidate architectures 221. The candidate architecture 221 is represented in one-dimensional vector format for each operation between nodes in a calculation cell.

In this example embodiment, unlike the architecture sampling means 102 in the first example embodiment, the architecture sampling means 202 does not sample parameters. The architecture sampling means 202 outputs candidate architectures with undetermined parameters.

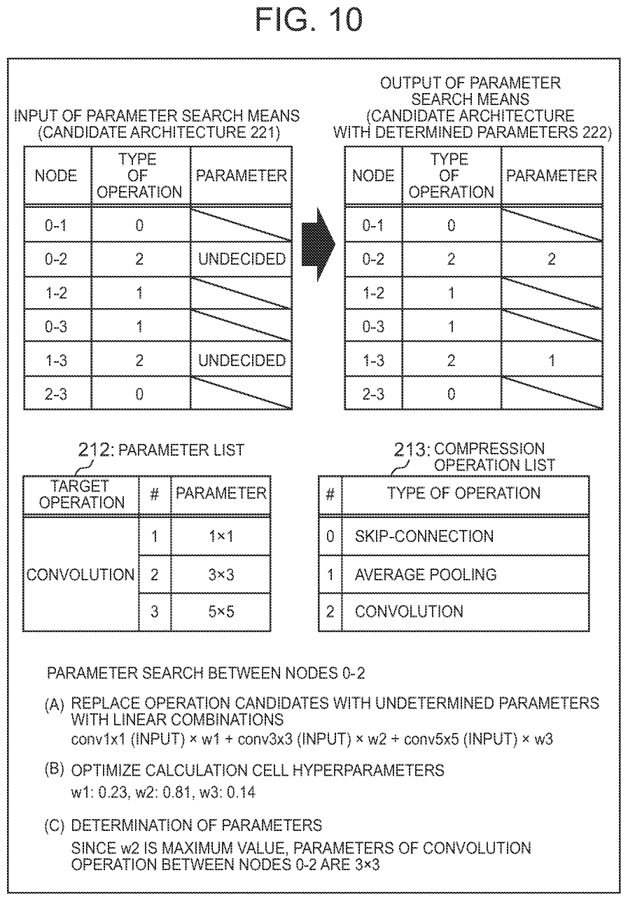

FIG. 10 is an explanatory diagram showing an example of inputs to and outputs from the parameter search means 201. In the example shown in FIG. 10, the parameter search means 201 inputs candidate architecture 221. The parameter search means 201 outputs the candidate architecture 222 whose parameters have been determined. FIG. 10 also shows an example of a parameter list 212 input to the search space dimensionality compression means 101 and an example of a compression operation list 213 output from the search space dimensionality compression means 101.

The parameter search means 201 receives a candidate architecture 221 with undetermined parameters and a parameter list 212. The parameter search means 201 searches for the parameters of candidate architecture 221 and determines the parameters. The parameter search means 201 replaces the candidate operations for determining the parameters with linear combinations to form calculation cell 600, as shown in FIG. 8. Each candidate operation in each linear combination has a calculation cell hyperparameter 611, which is a parameterized weight. The calculation cell hyperparameter 611 is optimized by the evaluation function, and the optimal parameter is determined.

FIG. 10 shows an example of the replacement by the parameter search means 201 to linear combination, an example of the optimization of the calculation cell hyperparameters 611, and an example of the determination of the optimal parameters, in (a) through (c).

The architecture evaluation means 103 outputs candidate architectures 222 for the input target data set 114, using an arbitrary evaluation function to produce a single numerical value that is a criterion of the architecture's performance. The output of the evaluation function is a value of the architecture's representation capability, inference error, computational complexity, model size, etc., or a weighted sum of these values, which represents the performance of the network architecture.

The architecture performance prediction means 204 includes a machine learning model, such as a random forest, as the performance predictor described above. The architecture performance prediction means 204 performs the process of training a given input-output pair and inferring an output for an unknown input. Input value is candidate architecture. Output value is the quantified performance of the architecture. The quantified performance of the architecture is the performance value.

The architecture storage device 105 has the same functions as the architecture storage device 105 in the first example embodiment.

### [Description of Operation]

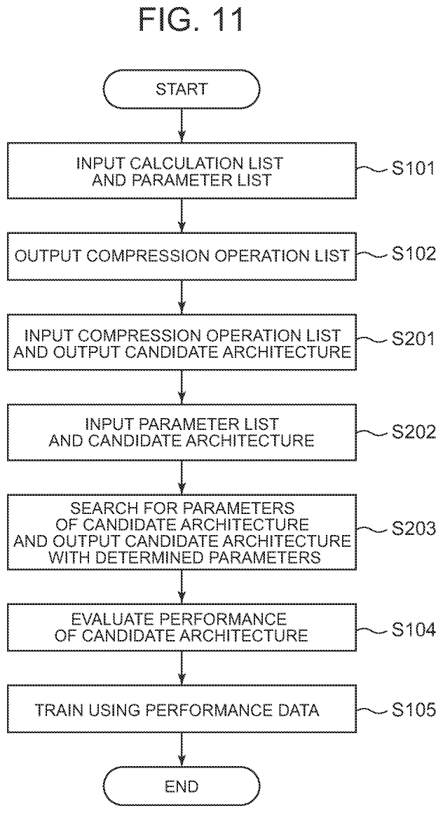

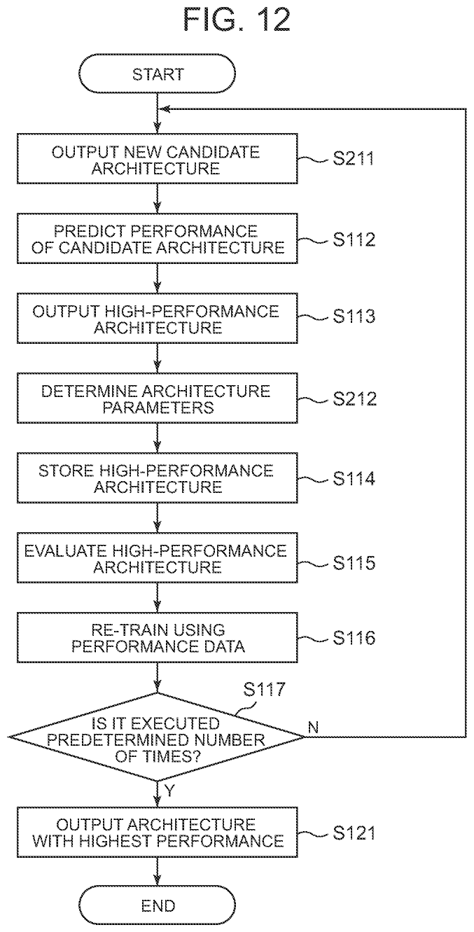

Next, the operation of the neural network structure search device 200 is described with reference to the flowcharts in FIGS. 11 and 12. FIG. 11 shows the processing of the training phase of the performance predictor. FIG. 12 shows the processing of the reinforcement phase of the performance predictor and the architecture selection phase.

In the training phase of the performance predictor, the search space dimensionality compression means 101 receives as input an operation list 111 of predefined calculation cell and a parameter list 112 to be compressed (step S101). Then, the search space dimensionality compression means 101 creates a compression operation list 213 based on the operation list 111 and parameter list 112, and outputs the compression operation list 213 to the architecture sampling means 202 (step S102). The process for creating the compression operation list 213 is the same as the process in the first example embodiment.

The architecture sampling means 202 outputs the candidate architectures 221 in one-dimensional vector format (step S201). In step S201, the architecture sampling means 202 represents the vector of compression operation lists 213 as a one-hot signal for each operation between nodes.

The parameter search means 201 receives the candidate architecture 221 and the input parameter list 212 (step S202). The parameter search means 201 reconstructs the calculation cell 600 by replacing the candidate operations containing parameters in the calculation cell 600 with weighted linear combinations parameterized by the calculation cell hyperparameters 611, as shown in FIGS. 8 and 10 (refer to (A) in FIG. 10).

Next, the parameter search means 201 updates the calculation cell hyperparameters 611 by optimizing the calculation cell hyperparameters 611 (refer to (B) in FIG. 10). The parameter search means 201 can perform the optimization using, for example, the error backpropagation method described in Patent Literature 1. The parameter search means 201 then calculates the values of the parameters of the operation to be compressed (refer to (C) in FIG. 10). The parameter search means 201 outputs the candidate architecture 222 whose parameters have been determined (step S203).

The architecture evaluation means 103 receives the candidate architecture 222 whose parameters have been determined. The architecture evaluation means 103 evaluates the performance of the candidate architecture 222 using an evaluation function (step S104). In step S104, the architecture evaluation means 103 calculates, for example, criteria representing the performance. The architecture evaluation means 103 can also calculate criteria representing the performance of the candidate architecture using the input target data set 114.

The architecture performance prediction means 204 performs training using a machine learning model (step S105). In other words, the architecture performance prediction means 204 trains the performance predictor using the candidate architecture as input and the teacher data as performance. Unlike in the first example embodiment, the machine learning model is given the candidate operations in the calculation cell 600 as input, but does not include the values of the parameters.

Next, the reinforcement phase process of the performance predictor is executed. In the reinforcement phase, as in the training phase, the architecture sampling means 202 outputs one or more new candidate architectures 221 to the architecture performance prediction means 204 (step S211).

The architecture performance prediction means 204 predicts the performance of the candidate architectures 221 using the performance predictors trained in the training phase (step S112). The architecture performance prediction means 204 gives one or more of the architectures predicted to have high performance among the multiple candidate architectures 221 predicted to the parameter search means 201 (step S113). The parameter search means 201 determines the parameters of the candidate architectures 221 with undetermined parameters (step S212). Then, the parameter search means 201 gives the candidate architecture whose parameters have been determined to the architecture storage device 105 and the architecture evaluation means 103 as an architecture.

The architecture storage device 105 stores architectures that are predicted to perform well (step S114). The architecture evaluation means 103 evaluates the performance of the architecture using the evaluation function used in the training phase (step S115). The architecture evaluation means 103 outputs the performance values of the architecture to the architecture performance prediction means 204. The architecture performance prediction means 204 trains the performance predictor as in the training phase (step S116). As the performance predictor is re-trained, the prediction performance of the performance predictor is enhanced.

Processing of steps S211 to S117 is repeated a predetermined number of times. By repeating processing of steps S211 to S117 a predetermined number of times, a certain number of architectures with high performance are stored in the architecture storage device 105.

In the architecture selection phase, the architecture storage device 105 selects one of the stored architectures with the highest performance and outputs it (step S121). In this way, the architecture with the highest performance is finally obtained.

### [Effect Description.]

The neural network structure search device 200 of this example embodiment only needs to perform calculations concerning the hyperparameters of some operations in a calculation cell. Therefore, in this example embodiment, the effect of the first example embodiment can be obtained and the memory usage can be reduced compared to a device that performs calculations regarding the hyperparameters of all the operations in a calculation cell, as described in Patent Literature 1.

### [Example.]

Next, a specific example will be described. In the first example embodiment, the user defines the operation list 111 and the parameter list 112 to be compressed shown in FIG. 4, and inputs them to the search space dimensionality compression means 101.

In the first example, suppose that nine types of operations are set in operation list 111, i.e., non-connection, skip-connection, average pooling, convolution operation with a kernel size of 1×1, convolution operation with a kernel size of 3×3, convolution operation with a kernel size of 5×5, grouped convolution operation with a kernel size of 3×3 and number of groups of 2, grouped convolution operation with a kernel size of 3×3 and number of groups of 4, and grouped convolution operation with a kernel size of 3×3 and number of groups of 8. Suppose that the parameters for the convolution operations are set to 1×1, 3×3, and 5×5 in the parameter list 112. Also, suppose that 1, 2, 4, and 8 are set as parameters for grouped convolution in the parameter list 112.

As operations other than the above operations, it is possible to candidate operations used in neural networks, such as max pooling, non-connection, and normalization, or layers consisting of multiple operations in which the operations are combined. For example, as parameters other than the above operations, it is possible to candidate the number of strides, expansion rate, and number of channels for convolution and pooling operations.

The search space dimensionality compression means 101 compresses (compiles) a group of operations of the same type or having the same role targeted by the parameter list 112 in the nine types of operations into a single operation. In this example, the search space dimensionality compression means 101 compiles multiple convolutional operations with different kernel sizes as the same type of operation into a single convolutional operation. Also, the search space dimensionality compression means 101 compiles multiple grouped convolution operations with different numbers of groups into a single grouped convolution. As a result, the search space dimensionality compression means 101 creates a compression operation list 113 with an element count of 5, which includes non-connection, skip-connection, average pooling, convolution, and grouped convolution as operation types.

As other examples of the same type of operation, there may be operations that have different stride numbers, expansion rates, number of channels, etc., as well as operations that have different kernel sizes and number of groups.

Further, as an example of operations having the same role, there may be an operation having the role of reducing the size of the feature map, such as a convolution layer with a stride number of 2 and an average pooling with a stride number of 2.
Further, as an example of operations having the same role, there may be an operation that perform non-parametric operations on feature maps and output them to the next layer, such as average pooling with a stride number of 1 and max pooling with a stride number of 1. Further, the operation having the same role may include the number of repetitions of operations when one edge includes multiple operations.

The architecture sampling means 102 samples architectures that can be composed of the compression operation list 113 and the parameter list 112 under an arbitrary probability distribution. Specifically, the architecture sampling means 102 samples (selects) one operation from the operation list 111 as a candidate operation. When the operation is a compressible operation, i.e., a compressive operation (aggregable operation), the architecture sampling means 102 selects a parameter from the parameter list 112. The selected candidate operations and parameters constitute candidate architecture 121 (refer to FIG. 5A). The representation format of the candidate architecture 121 is a list format in which the operations (specifically, the operation data representing the type of operation) and parameters (specifically, the parameter data) are combined (refer to FIG. 5B). The operation data is represented by a one-hot signal with a length of 5. The parameter data is represented by one value for one parameter. As an example, parameter data is represented by a value by index. For example, the index is 1 for 1×1, 2 for 3×3, and 3 for 5×5. The architecture sampling means 102 assigns out-of-range values, such as 0 or −1, to operations that are not compression operations.

When a convolutional operation with a kernel size of 3×3 and a number of groups of 2, for example, is selected by the architecture sampling means 102 for the coupling between certain nodes in a calculation cell, the candidate architecture is represented by seven elements, as in [0 0 0 0 1 0 2] (the first through fifth elements are one-hot expression values for the type of operation, the sixth element is the kernel size index of the convolution operation, and the seventh element is the index of the grouped convolution operation). When the number of nodes in a calculation cell is 4, the number of connections between nodes is (4×(4−1))/2=6. Therefore, the architecture of the entire search cell is represented by 7×6=42 elements. When the architecture sampling means 102 in the first example embodiment is not used, the architecture is represented by 9×6=54 elements. The architecture output by the architecture sampling means 102 is the candidate architecture 121.

The architecture evaluation means 103 evaluates the candidate architectures 121 with an evaluation function. The evaluation function includes the loss due to the difference from the teacher labels when the target data set 114 is input, the difference from the teacher model, and a numerical value that evaluates the performance of the model. In the evaluation function, the weighted sum of these may be the loss. In the Non-Patent Literature 1, the weighted sum of the loss of the teacher labels when the target data set is input to the candidate architecture and the amount of mutual information in the middle layer with the teacher model is employed. The teacher model is a model trained on the same dataset with an already existing architectural structure. The architectural structure is defined as the architecture with higher performance for smaller values of the above weighted sum.

The architecture performance prediction means 104 trains the performance above to the performance predictor. The input to the performance predictor is the candidate architecture 121 and the output is the performance. The performance predictor is a machine learning method that can represent the input-output relationship.

Random forests are used as machine learning. In a random forest, the input is a 1-dimensional vector with 42 elements representing the architecture of the entire search cell. The output is a two-class classification of high-performance and low-performance models. To distinguish between high-performance and low-performance models, the values of the evaluation functions of the candidate architectures are separated by an arbitrary threshold value.

After training the performance predictor, it moves to the reinforcement phase. In the reinforcement phase, the architecture sampling means 102 samples one or more new candidate architectures 121. The architecture performance prediction means 104 infers the performance of the candidate architectures 121 with the trained performance predictor. As a result, it is possible to store the architectures classified into a high-performance class in a list format in the architecture storage device 105, and the architecture evaluation means 103 can again calculate the performance using the evaluation function. The architecture performance prediction means 104 re-trains the performance predictor using the pairs of performance and architecture. The re-training is repeated until specified conditions are achieved. The conditions include, for example, a predetermined number of times or the number of architectures with high performance stored.

In the architecture selection phase, the architecture storage device 105 outputs the best architecture from among the stored architectures. In this way, the user can obtain the best architecture for the target data set.

Next, a second example corresponding to the second example embodiment will be described. In the second example embodiment, in addition to the components in the first example embodiment, there is the parameter search means 201. The operation of the architecture sampling means 202 and the architecture performance prediction means 204 differs from the operation of the architecture sampling means 102 and the architecture performance prediction means 104 in the first example embodiment. The architecture sampling means 202 does not determine the parameters of the operations listed in the parameter list. The architecture sampling means 202 samples from among the architectures composed only by the compression operation list 213 (refer to FIG. 10).

Therefore, the output candidate architecture 221 depends only on the compression operation list 213, and in this example, the number of elements in the compression operation list 213 is 5×6=30. The parameter search means 201 operates when the candidate architecture 221 includes a compression operation, and searches for the parameters of the compression operation. As shown in FIG. 10, the parameters are expressed as a sum of linear combinations of candidate operations weighted by the calculation cell hyperparameters 611.

In this example, the parameter search means 201 replaces the operations between nodes for which convolutional operations are selected with weighted linear combination operations of three operations with kernel sizes 1×1, 3×3, and 5×5. The parameter search means 201 also replaces the operations between nodes for which grouped convolution operations have been selected with weighted linear combination operations of four operations with group sizes 1, 2, 4, and 8. The parameter search means 201 determines the parameters by optimizing the architecture's calculation cell hyperparameters 611 by loss functions. The performance predictor of the architecture performance prediction means 204 performs training and inference with respect to the performance of the candidate architecture whose parameters are undetermined. Therefore, architectures that are determined to have high performance during inference have undetermined parameters. Therefore, after the parameter search means 201 determines the parameters of the candidate architecture whose parameters are undetermined, and the architecture storage device 105 stores the architecture that is predicted to have high performance, the same process as in the first example embodiment is performed.

Each function (each process) in the above example embodiments can be realized by a computer having a processor such as a CPU (Central Processing Unit) and memory. For example, a program for implementing the method (processing) in the above example embodiment may be stored in a storage device (storage medium), and each function may be realized by executing the program stored in the storage device by a CPU.

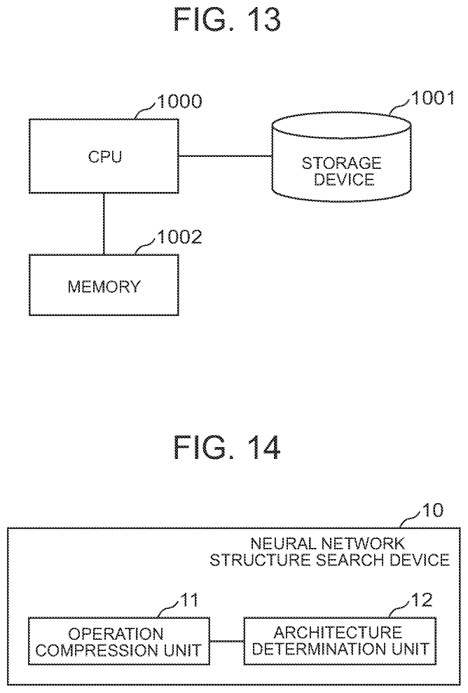

FIG. 13 is a block diagram showing an example of a computer having a CPU. The computer is implemented in the neural network structure search devices 100 and 200. The CPU 1000 realizes each function in the above example embodiments by executing processing according to a program (software element: code) stored in the storage device 1001. In other words, it realizes the functions of the search space dimensionality compression means 101, the architecture sampling means 102, the architecture evaluation means 103, and the architecture performance prediction means 104 in the neural network structure search device 100 shown in FIG. 3. It also realizes the functions of the search space dimensionality compression means 101, the architecture sampling means 202, the parameter search means 201, the architecture evaluation means 103, and the architecture performance prediction means 204 in the neural network structure search device 200 shown in FIG. 9.

The storage device 1001 is, for example, a non-transitory computer readable medium. Non-transitory computer readable media includes various types of tangible storage media. Examples of non-transitory computer readable media include magnetic storage media (e.g., hard disks), magneto-optical storage media (e.g., magneto-optical disks), CD-ROM (Compact Disc-Read Only Memory), CD-R (Compact Disc-Recordable), CD-R/W (Compact Disc-Rewritable), semiconductor memory (e.g., mask ROM, PROM (Programmable ROM), EPROM (Erasable PROM), Flash ROM).

The program may also be stored on various types of transitory computer readable media (transitory computer readable medium). The transitory computer readable medium is provided with the program via, for example, wired or wireless communication paths, i.e., electrical, optical, or electromagnetic signals.

The memory 1002 is realized by, for example, RAM (Random Access Memory) and is storage means for temporarily storing data when the CPU 1000 executes a process. It can be supposed that a program held by the storage device 1001 or a temporary computer readable medium is transferred to the memory 1002, and that the CPU 1000 executes processing based on the program in the memory 1002. The architecture storage device 105 can be realized in the memory 1002 or in the data-writable storage device 1001.

FIG. 14 is a block diagram showing the main part of the neural network structure search device. The neural network structure search device 10 shown in FIG. 14 includes an calculation compression unit (calculation compression means) 11 (in the example embodiments, it is realized by the search space dimensionality compression means 101) that compiles multiple operations included in the operation space that is a candidate for search into a single operation and an architecture determination unit (architecture determination means) 12 (in the first example embodiment, it is realized by the architecture sampling means 102, the architecture evaluation means 103, and the architecture performance prediction means 104, in the second example embodiment, it is realized by the architecture sampling means 202, the architecture evaluation means 103 the architecture performance prediction means 204, and the parameter search means 201) that determines an architecture with high performance from the candidate architectures that include the compiled operation.

In the neural network structure search device 10, the architecture determination unit 12 may include a prediction unit that predicts the performance of the architecture based on the candidate architectures (prediction means: in the first example embodiment, it is realized by the architecture performance prediction means 104).

In the neural network structure search device 10, the architecture determination unit 12 may include a parameter search unit that searches for parameters of candidate architectures whose parameters are unknown (parameter search means: in the second example embodiment, it is realized by the parameter search means 201).

1. A neural network structure search device that searches for a neural network architecture, comprising:
a memory storing software instructions, and
one or more processors configured to execute the software instructions to
compile multiple operations as candidates for search included in an operation space into a single operation, and
determine a high performance architecture from candidate architectures that include the compiled operation.

2. The neural network structure search device according to claim 1, wherein
the one or more processors configured to execute the software instructions to compile operations of the same type or with the same role into one operation.

3. The neural network structure search device according to claim 1, wherein
the one or more processors configured to execute the software instructions to compile multiple operations into a single operation using a parameter to be compressed.

4. The neural network structure search device according to claim 3, wherein
the one or more processors configured to execute the software instructions to predict performance of architecture based on the candidate architectures.

5. The neural network structure search device according to claim 3, wherein
the one or more processors configured to execute the software instructions to search for a parameter of candidate architectures whose parameter is unknown.

6. The neural network structure search device according to claim 5, wherein
the one or more processors configured to execute the software instructions to search for parameter in a parameter space to be searched.

7. The neural network structure search device according to claim 2, wherein
the one or more processors configured to execute the software instructions to compile multiple operations into a single operation using a parameter to be compressed.

8. The neural network structure search device according to claim 7, wherein
the one or more processors configured to execute the software instructions to predict performance of architecture based on the candidate architectures.

9. The neural network structure search device according to claim 7, wherein
the one or more processors configured to execute the software instructions to search for a parameter of candidate architectures whose parameter is unknown.

10. The neural network structure search device according to claim 9, wherein
the one or more processors configured to execute the software instructions to search for a parameter in a parameter space to be searched.

11. A neural network structure search method that searches for a neural network architecture, comprising:
compiling multiple operations as candidates for search included in an operation space into a single operation by a computer, and
determining a high performance architecture from candidate architectures that include the compiled operation by the computer.

12. The neural network structure search method according to claim 11, wherein
the computer compiles operations of the same type or with the same role into one operation.

13. A non-transitory computer readable storage medium for storing a neural network structure search program that searches for a neural network architecture for causing a computer to execute:
a process of compiling multiple operations as candidates for search included in an operation space into a single operation, and
a process of determining a high performance architecture from candidate architectures that include the compiled operation.

14. The non-transitory computer readable storage medium according to claim 13, wherein
the neural network structure search program causes the computer to compile operations of the same type or with the same role into one operation.
